(19) United States
(12) Patent Application Publication
(10) Pub. No.: US 2009/0315381 A1
(43) Pub. Date: Dec. 24, 2009

(54) AIRPLANE AUXILIARY ARMREST

(76) Inventor: ADAM LONGNECKER, SNOWMASS VILLAGE, CO (US)

Correspondence Address: ADAM LONGNECKER, PO BOX 6858, 724 HAWK RIDGE LANE,SNOWMASS VILLAGE, COLORADO, SNOWMASS VILLAGE, CO, 81615, US

(21) Appl. No.: 12/486,154

(22) Filed: Jun. 17, 2009

Related U.S. Application Data
(60) Provisional application No. 61/073,373, filed on Jun. 18, 2008.

(51) Int. Cl. B60N 2/46

(52) U.S. Cl. 297/411.23

(57) ABSTRACT

Airplane auxiliary armrests enclosed to solve the problem of uncomfortable aircraft seating. Many consumers who sit in aircrafts have no or inadequate padding on the chair arms, will be able to attach the armrest in a matter of minutes and therefore experiencing more comfortable armrest while they are sitting in the chair. The airplane auxiliary armrests are designed to slide over the top of an existing airline armrest. The aircraft auxiliary armrest will be made of high density foam within and encased in a soft resilient material.

### FIELD OF THE INVENTION

The present invention relates to an aircraft armrest. In particular, the present invention, especially for aircrafts, is a seat components in the form of an armrest, an arm-like operating part being present which extends projecting at least partially above the existing airline armrest of the seat, and operating elements which are used at least in part to enhance comfort and/or which are suitable for this purpose within the context of operation, especially flight operation. The present invention relates to an armrest member, particularly adapted for use with seating units used in association with aircraft furniture.

### BACKGROUND OF THE INVENTION

Vehicle seats, air passenger seats or motor passenger seats in particular, are known in a plurality of embodiments. Modern vehicle seats have a large number of possible settings for the seat component and the back rest. In addition, good upholstery and armrests increasing comfort are currently included in the standard.

Armrest pads/cushions were invented and developed due to a lack of available comfortable arm pads for general seating. Regarding arm comfort in vehicles, especially aircrafts, however, much remains to be desired. While high-quality vehicle seats such as are used in first class or business class, also have armrests, the support surface is a hard and integral component of the seat. This creates lack of comfort for persons who spend long periods of travel in an aircraft seat which has non resilient cloth, plastic, rubber, or hard metal or wooden armrests.

The present invention is portable and can be carried with the owner to each new aircraft or attached permanently to any chair's arms.

The relevant prior art methods, which will deal with armrests for holding purpose are as follows:

U.S. Pat. No. 6,866,341 describes a vehicle seat for aircraft and motor vehicles, includes a back rest and a seat part supported by a seat frame connected to a vehicle floor. One support arm pivotally supports on one of its ends a combined foot and leg support as separate surfaces of a bracing component. The support arm is coupled to the seat frame at its other free end in a pivotable manner and may be adjusted detent-wise through preset positions. The foot and the leg support are arranged on opposite faces of the support piece.

U.S. Pat. No. 7,108,328 claims a vehicular armrest that has a fixed axle carrying primary and secondary parts formed with meshing arrays of sawteeth angled to inhibit movement of the arm-rest body in a downward direction between a raised position and the lowered position but permit movement of the arm-rest body in the upward direction between the lowered position to the raised position.

US Patent Application No. 20050269451 discloses a flight passenger seat that comprises a back element, a seat element and an armrest. Seat element, back element and armrest may be able to be pivoted. Reset elements for an automatic pivoting are integrated into the back element and the seat element in such a way that they occupy as little space as possible of a traffic area, which has to be kept clear. In an advantageous manner, this allows for an enlargement of a traffic area in an airplane and thereby may effectuate a reduction of a “turn around” time of an airplane.

US Patent Application No. 20060001302 explains about a vehicle seat system, especially for aircraft, with seat components such as a backrest and a seat part which is bordered at least on one side by a console which forms the armrest, an arm-like operating part being present which extends projecting at least partially above the plane of the head of the seat occupant, and has operating elements which are used at least in part to enhance comfort and/or which are suitable within the context of operation, especially flight operation, for this purpose. Because the arm-like operating part forms a widening of the console and extends forward proceeding from the area of the backrest above the console in an extension thereof, and because the arm-like operating part is configured as a rigid arched support, an aesthetically pleasing solution is obtained which requires little installation space and saves weight and which can be regarded as a multifunction solution.

US Patent Application No. 20070152488 discloses an armrest for furniture or other chair or seating applications is described. The armrest includes a cushion member, a frame component, and an optional covering or protective layer. In certain applications, the armrest is formed from a vertically lapped fibrous batt.

US Patent Application No. 20070262635 claims a passenger seat with increased knee space for an aft-seated passenger, including a seat base for being attached to a supporting deck and at least one seat frame including a seat back and seat bottom carried by the seat base. At least one armrest assembly is carried by the seat frame and including an armrest mounted for pivotal movement about a pivot member between a use position with an upper support surface in a horizontal position for supporting a forearm of a passenger seated in the seat, and a stowed position wherein the upper support surface of the armrest is perpendicular to the use position. The armrest pivot member is mounted on the seat frame at a point forward of a plane defined by the seat back carried by the seat and above a point defined by the seat bottom for allowing the knee of an aft-seated passenger to occupy space behind the pivot member of the armrest.

However the purpose and methodology of the above inventions are part of prior art do not envisage an ergonomic armrest that maintains health through good body posture. They also do not address the use of material on the armrest to maintain the comfort of the passenger. The above inventions further do not envisage an aircraft auxiliary armrest that is light weight and can be easily transported. The present invention differs from the existent prior art in that it fulfills the above objectives.

### SUMMARY OF THE INVENTION

This invention may be summarized, at least in part, with reference to its objects.

The primary object of this invention is to slide over the top of an existing airline armrest.

Another object of the invention is to add comfort to the armrest of commercial airline seats.

Another object of the invention will be made of high density foam within and encased in a soft resilient material.

Yet another object of the invention is to provide a convenient armrest position that does not interfere the side of the passengers body.

It is another object of the invention to provide an armrest that is light weight and can be easily transported.

These and other objects of the present invention are achieved in the preferred embodiments disclosed below by providing an aircraft auxiliary armrest. The aircraft auxiliary armrest can be mounted on the existing arm of the seat frame in a horizontal position for supporting a forearm of a passenger seated in the seat.

The present invention will be more readily apparent when considered in reference to the following description and when taken in conjunction with the accompanying drawings.

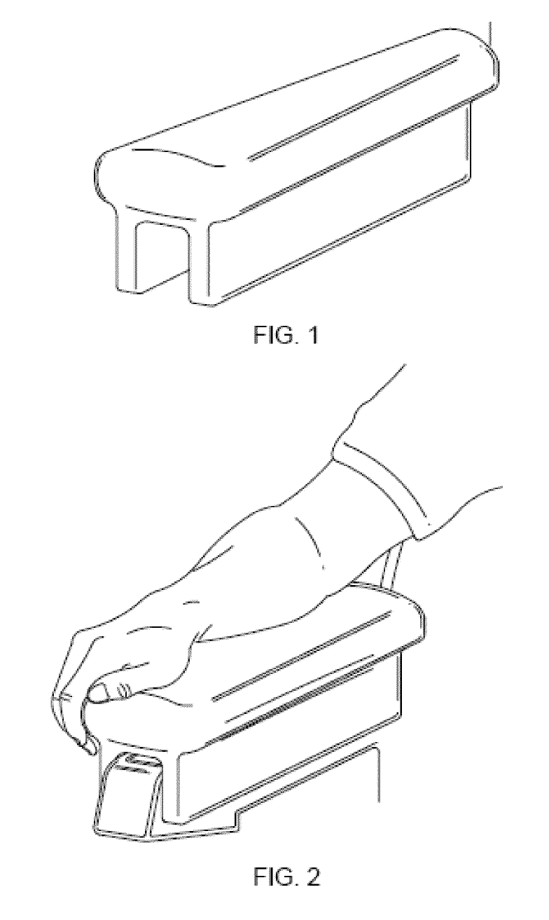

FIG. 1 is a perspective diagram of the aircraft auxiliary armrest.

FIG. 2 is a perspective diagram of the method of attaching to the aircraft auxiliary armrest attached to the aircraft arm frame.

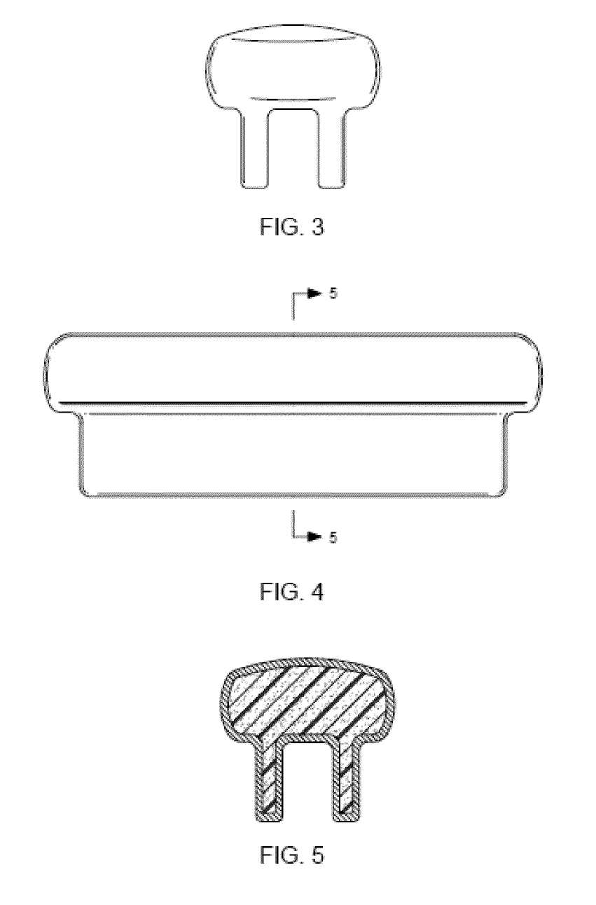

FIG. 3 is a diagram of a front view of the aircraft auxiliary armrest.

FIG. 4 is a diagram of a side view of the aircraft auxiliary armrest.

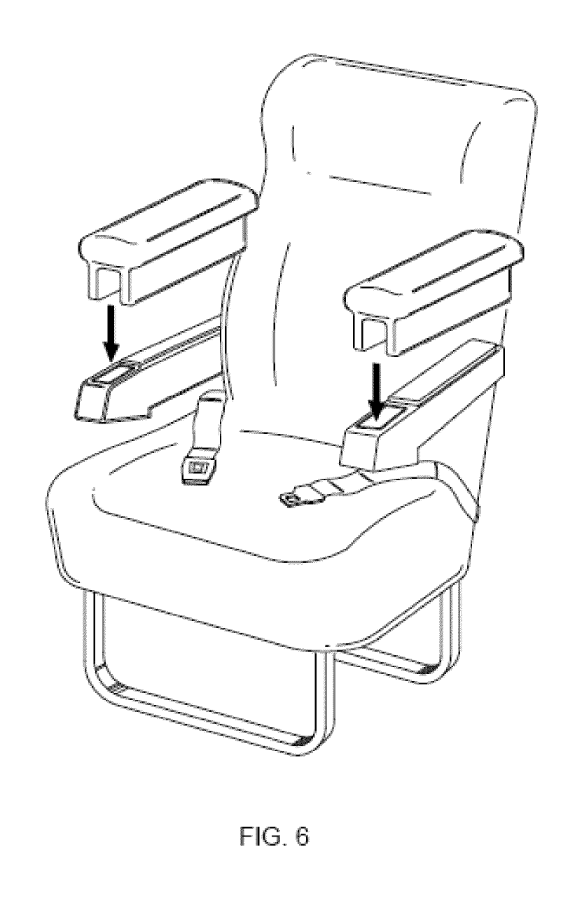

FIG. 5 is a cross section diagram of a front view of the aircraft auxiliary armrest.

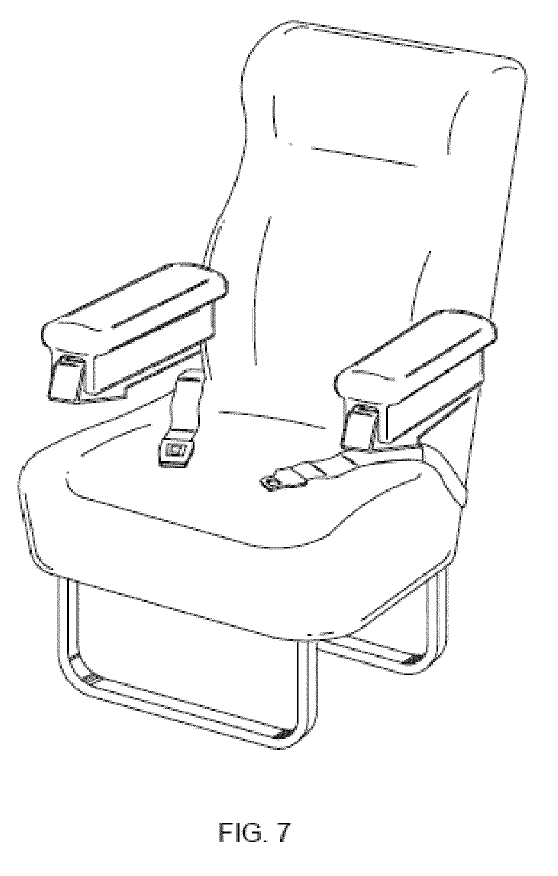

FIG. 6 is a perspective diagram of the method of attaching to the aircraft auxiliary armrest attached to the aircraft arm frame.

FIG. 7 is a perspective diagram of the fixed aircraft auxiliary armrest.

### DETAILED DESCRIPTION OF THE INVENTION

The following description is presented to enable any person skilled in the art to make and use the invention, and is provided in the context of particular applications of the invention and their requirements. The present invention can be configured as follows:

The preferred embodiment aircraft auxiliary armrest according to the present invention is formed from a particular material, and fashioned in such a manner that a unique combination of properties relating to both comfort and durability are achieved. The preferred embodiment using the materials of construction described herein can also feature the particular shape and configuration as shown in the referenced figures. These and other aspects are described in greater detail herein.

The preferred embodiment aircraft auxiliary armrest comprises a frame component, a cushion member formed above the frame component, and an optional, however preferred, layer of a protective or decorative cover overlaying at least the cushion member.

The frame component of the preferred embodiment aircraft auxiliary armrest can be formed with a greater density and rigidity, than the cushion member. Structural characteristics of the cushion member or the frame component may also be controlled by adjustment of the material density. The frame component is structured based on the general standard measurements of the flight seat armrest so that it can be fixed to the top of the flight armrest in such a fashion that it gets adjusted to the seat armrest and does not slip or slither thereby offering the maximum comfort to the passenger.

Preferably, the cushion member is a unified or flexible member and includes a resilient cover filled with high density foam. Foam production technology has made some very significant advances in the past decade. Foams of varying densities (Quality) and ILD (firmness) ratings are now produced which offers an opportunity to select a specific type of foam based upon its intended use. The foam for use in the cushion member provides structure and strength characteristics. More than one type of foam may be used in the construction of the cushion member. The foam used in the armrest is high density foam that lasts for longer days and offers the maximum comfort to the passenger.

The other component of the cushion member is the resilient cover that has a specific characteristic to restore its shape even after being crushed. This offers additional support to the foam filled inside the material, to restore its shape when the passenger exerts pressure on the armrest.

The aircraft auxiliary armrest is light weight and can be easily transported in a carry case. On board the aircraft, the aircraft auxiliary armrest can be placed on the aircraft arm frame by sliding the two vertical sides of the aircraft auxiliary armrest over the aircraft arm frame.

It will be apparent to those skilled in the art that the objects of this invention have been achieved by providing the components. Various changes may be made in the structure of the armrest. Further, features of some components disclosed in this application may be employed with features of other embodiments. Therefore, the scope of the invention is to be determined by the terminology of the following claims and the legal equivalents thereof.

What is claimed is:

1: An Airplane Auxiliary Armrest comprising of an armrest containing frame component and cushion component, characterized in that said frame component is structured based on the measurements of the flight seat armrest so that it can be fixed to the top of the flight armrest in such a fashion that it gets adjusted to the seat armrest.

2: Airplane Auxiliary Armrest as claimed in claim 1 wherein the said invention comprises a layer of a protective or decorative cover overlaying at least the cushion member.

3: Airplane Auxiliary Armrest as claimed in claim 1 wherein the said frame component of the auxiliary armrest can be formed with higher density foam to give a rigid structure.

4: Airplane Auxiliary Armrest as claimed in claim 1 wherein the said cushion component comprising resilient cover filled with high density foam.

5: Airplane Auxiliary Armrest as claimed in claim 1 wherein the structural characteristics of the cushion component or the frame component is controlled by the adjustment of the material density.

6: Airplane Auxiliary Armrest as claimed in claim 1 wherein the said resilient cover is designed in a specific character to restore its shape even after being crushed.

7: Airplane Auxiliary Armrest as claimed in claim 1 wherein the said invention is lightweight.

8. Airplane Auxiliary Armrest as claimed in claim 1 wherein the said invention is compact and easily transportable.
